(19) United States
(12) Patent Application Publication
(10) Pub. No.: US 2008/0060415 A1
(43) Pub. Date: Mar. 13, 2008

(54) Method for testing a stored gas container

(75) Inventors: William B. Butler, Mesa, AZ (US); Mark S. Lovell, Mesa, AZ (US); Christopher J. Ruf, Mesa, AZ (US); Barry F. Shaffer, Mesa, AZ (US); Dennis L. Paschall, Mesa, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/520,410

(22) Filed: Sep. 13, 2006

(51) Int. Cl. G01M 3/02

(52) U.S. Cl. 73/37

(57) ABSTRACT

A method is provided for assessing whether a container (12) for a stored gas can maintain a predetermined gas pressure. The method includes the steps of: producing a magnetic field with an inductive heating element (19, 35); placing the container (12) containing a quantity of the stored gas in the magnetic field; inductively heating the container (12) to elevate the pressure of the stored gas to an elevated pressure greater than the predetermined gas pressure; and thereafter testing the container (12) for an indication of potential inability of the container to maintain the stored gas at the predetermined gas pressure.

### TECHNICAL FIELD

The present invention relates to a method for testing a stored gas container. More particularly, the present invention relates to a method for pressure testing stored gas containers.

### BACKGROUND OF THE INVENTION

A stored gas container is often used in a vehicle occupant protection system to provide inflation fluid for inflating an air bag. The gas stored in the stored gas container is generally pressurized and may include a single gas alone, a mixture of gases, or a combination of a single gas or a mixture of gases and an ignitable material for heating the gas or gas mixture. The ignitable material may be solid ignitable material or a fuel gas.

To assess whether the stored gas container can, without leaking over time, maintain sufficient pressure, a pressure test is performed on selected filled containers. One currently performed pressure test includes heating the stored gas container to increase the pressure of the gas. During this type of pressure test, a statistically significant number of the stored gas containers are removed from the assembly line and placed in an oven for a predetermined period of time. The oven is heated to a temperature for increasing the pressure of the stored gas to a predetermined value, generally 1.5 times the designated fill pressure of the stored gas. This pressure test is inefficient, however, due to the necessity of removing the stored gas containers from the assembly line. Also, this pressure test is performed on only a selected number of the stored gas containers. A more efficient pressure test in which all of the stored gas containers are tested is desirable.

### SUMMARY OF THE INVENTION

The present invention relates to a method for assessing whether a container for a stored gas can maintain a predetermined gas pressure. The method comprises the steps of: producing a magnetic field with an inductive heating element; placing the gas container containing a quantity of stored gas in the magnetic field; inductively heating the gas container to elevate the pressure of the stored gas to an elevated pressure greater than the predetermined gas pressure; and thereafter testing the container for an indication of potential inability of the container to maintain the stored gas at the predetermined gas pressure.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of a first testing system for performing the method of the present invention; and

FIG. 2 is a schematic view of a second testing system for performing the method of the present invention.

### DETAILED DESCRIPTION OF THE INVENTION

The present invention relates to a method for testing stored gas containers. More particularly, the present invention relates to a method for testing stored gas containers that are to be used as inflation fluid sources for inflating an air bag or other inflatable device of a vehicle occupant protection system.

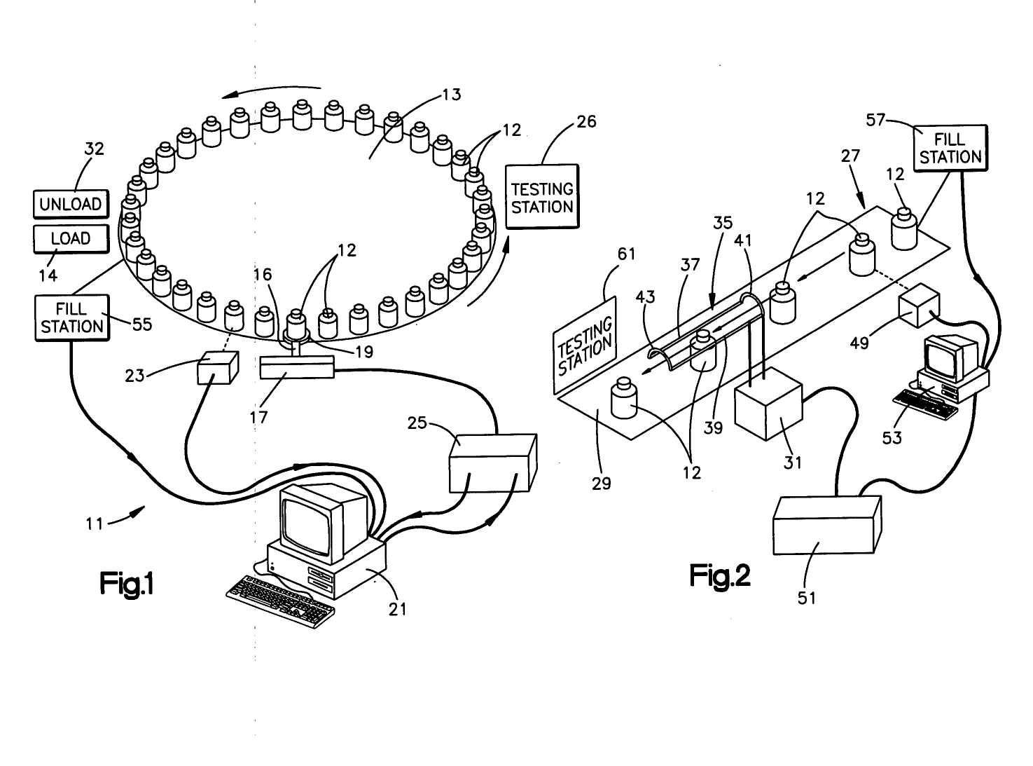

FIG. 1 illustrates a first system 11 for pressure testing stored gas containers 12 in accordance with the method of the present invention. The system 11 includes a conveyor for transporting the containers 12. The conveyor illustrated in FIG. 1 is a rotary table 13. The rotary table 13 rotates at a rate of approximately one revolution every six minutes in a counter-clockwise direction, as viewed in FIG. 1. Empty containers 12 are loaded successively onto the table 13. FIG. 1 schematically illustrates a loading area 14 adjacent the rotary table. Empty containers 12 are loaded onto the rotary table 13 in a manner such that the containers are spaced circumferentially from one another about the periphery of the rotary table. FIG. 1 illustrates the rotary table 13 holding thirty five containers 12. The table 13 can be designed to hold any number of containers 12.

A fill station 55 is associated with the rotary table 13. The fill station 55 includes mechanisms for filling the empty containers 12 with gas and sealing filled containers. Shortly after being loaded onto the rotary table 13, each empty container 12 enters the fill station 55, is filled with gas, and is sealed.

A heating station 17 is also associated with the rotary table 13. The heating station 17 is located downstream of the fill station 55 in the direction of rotation of the rotary table 13. The containers 12, after being filled with gas and sealed, pass successively into the heating station 17.

The heating station 17 includes an inductive heating element 19. The inductive heating element 19 is located on an arm 16 that is configured to move the inductive heating element vertically relative to the rotary table 13. Prior to a container 12 entering the heating station 17, the inductive heating element 19 is spaced away from the rotary table 13 by a distance sufficient to enable the container to enter the heating station 17. The rotary table 13 stops momentarily while the container 12 is at the heating station 17. While the rotary table 13 is stopped, the inductive heating element 19 is moved to a position proximate the container for heating the container. The inductive heating element 19 is again moved to a position spaced away from the rotary table 13 after the container 12 is heated so that the rotary table may rotate to move the container out of the heating station 17.

The heating station 17 is electrically coupled to a computer 21 and a power supply 25. The computer 21 is also electrically coupled to a pyrometer 23. The computer 21 controls operation of the heating station 17 and the pyrometer 23 and also records data associated with each container 12. The pyrometer 23 is located immediately upstream of the heating station 17 and is operable for measuring the temperature of the containers entering the filling station. The pyrometer 23 provides the measured temperature with the computer 21. The computer associates the measured temperature with the respective container.

The power supply 25 provides power to the heating station 17, computer 21, and pyrometer 23. The power supplied to the heating station 17 has an alternating current. Upon receiving the alternating current from the power supply 25, the inductive heating element 19 produces a magnetic field. When a container 12 is located at the filling station 17, the container 12 is located within the magnetic field and becomes inductively coupled to the inductive heating element 19. When a respective container is inductively coupled to the inductive heating element 19, the container 12 is heated. The heating of the container 12 heats the gas stored within the container. As a result, the pressure of the gas stored within the container 12 increases. The container is made of a conductive material, such as a ferrous metal, that allows for the heating of the gas in the container by the inductive heating element 19.

According to the method of the present invention, an empty container 12 is loaded onto the rotary table 13. The empty container 12 is moved into the fill station 55 by rotation of the rotation table 13 and is filled with gas. In one example, the container 12 is filled with a mixture of gases comprising air, helium, and hydrogen. During filling of the container 12 at the fill station 55, the amount or quantity of each gas that is introduced into the container 12 is determined. The determined amount of each of the gases is provided to the computer 21. The computer 21 associates the determined amounts of the gases with the respective container being filled and stores this data in memory. After the container 12 is filled with the gases, the container 12 is sealed.

After being filled and sealed, the container 12 is transported toward the heating station 17. Prior to reaching the heating station 17, the pyrometer 23 measures the temperature of container 12 and the measured temperature is provided to the computer 21. The computer 21 associates the measured temperature with the respective container and stores this data in memory.

After the temperature of the container is measured, the container 12 enters the heating station 17. When the container is located at the heating station 17, the rotation of the table 13 is stopped momentarily. The inductive heating element 19 is moved into a position proximate the container and power is supplied to the inductive heating element. In response to receiving power, the inductive heating element 19 produces a magnetic field for inductively coupling the inductive heating element and the container 12 located at the heating station 17. While producing the magnetic field, the inductive heating element 19 is moved vertically along the height of the container 12. The inductive coupling of the inductive heating element 19 and the container 12 heats the container. No contact occurs between the inductive heating element 19 and the container 12 during heating of the container.

Using the stored gas amounts and temperature for the respective container 12, the computer 21 controls the amount of power applied to the inductive heating element 19 and the period of time that the inductive heating element 19 produces the magnetic field so that the pressure of the gas within the container 12 is raised to a predetermined elevated pressure. The predetermined elevated pressure is generally equal to or greater than 1.5 times the designated fill pressure of the gas. In one example, the computer 21 may determine that the container 12 should be heated to approximately 150 degrees Celsius for the stored gas to reach the desired elevated pressure. The computer 21 then controls the inductive heating element 19 to heat the container 12 to this determined temperature.

After the container 12 is heated and the pressure of the gas within the container is raised to the predetermined elevated pressure, the inductive heating element 19 is moved away from the container 12. The rotary table 13 begins to rotate and the container 12 is moved away from the heating station 17. As one container 12 moves away from the heating station 17, the next container 12 enters the heating station 17 to be heated. This next container 12 is heated using the same steps as the previous container. The computer 21 adjusts the time period for heating the next container 12 based on the measured temperature and the stored gas amounts of the next container 12.

As a container 12 is moved away from the heating station 17, it is allowed to cool. Cooling generally occurs in a relatively short time period. The container 12 then enters a testing station 26. At the testing station 26, the container 12 is tested for actual leaks or one or more other indications of potential inability of the container 12 to maintain the stored gas at a predetermined gas pressure, which may be the designated fill pressure or another pressure.

For example, a ring test may be performed at the testing station 26 to determine if the hoop stress of the container 12 is adequate to prevent leakage over time. In another example, each of the containers 12 may be weighed upon arrival at the testing station 26 and then weighed again at a predetermined time after its arrival at the testing station 26. A leak is determined when the weight of the container 12 at a predetermined time after its arrival at the testing station 26 is less than the weight of the container 12 upon arrival at the testing station 26. After leaving the testing station 26, the container 12 remains on the rotary table 13 until reaching an unloading station 32. At the unloading station 32, the container 12 is removed from the rotary table 13.

FIG. 2 illustrates a second system 27 for performing a method in accordance with the present invention. The system 27 of FIG. 2 includes a belt conveyor 29 for transporting the containers 12 from right to left as viewed in FIG. 2. A fill station 57 for filling the containers 12 with gas and for sealing the containers 12 is associated with the belt conveyer 29 and is located near a loading area for the containers 12.

A heating station 31 is also associated with the belt conveyor 29. The heating station 31 is located downstream of the filling station 57 in the direction of movement of the belt conveyor 29. The heating station 31 includes an inductive heating element 35 that extends over the belt conveyor 29 and along part of the length of the belt conveyor 29. In particular, the inductive heating element 35 includes a first straight elongated portion 37 that is spaced from and parallel with a second straight elongated portion 39. The first and second elongated portions 37 and 39 extend horizontally over the belt conveyor 29. The inductive heating element 35 also includes an inverted u-shaped portion 41 that joins the first and second elongated portions 37 and 39 at their upstream ends and a similar inverted u-shaped portion 43 that joins the first and second elongated portions 37 and 39 at their downstream ends. Each of the inverted unshaped portions 41 and 43 extends vertically upwardly from the elongated portions 37 and 39.

The heating station 31 is electrically coupled to a power supply 51 and a computer 53. The computer 53 is also electrically coupled to a pyrometer 49. The power supply 51, computer 53, and pyrometer 49 operate in a manner similar to the power supply 25, the computer 21, and the pyrometer 23 described with reference to FIG. 1.

The power supplied to the heating station 31 has an alternating current. Upon receiving the alternating current from the power supply 51, the inductive heating element 35 produces a magnetic field. Each container 12 passing through the filling station 31 passes through the magnetic field produced by the inductive heating element 35 and becomes inductively coupled to the inductive heating element. When a respective container 12 is inductively coupled to the inductive heating element 35, the container 12 is heated. The heating of the container 12 increases the pressure of the gas stored within the container.

According to the method of the present invention, each container 12 is loaded onto the belt conveyor 29. The container 12 then enters the fill station 57. At the fill station 57, the container 12 is filled with gas and is subsequently sealed. During the filling process, the amount or quantity of each gas that is introduced into the container 12 is determined. The data related to the stored amount of each of the gases is supplied to the computer 53. The computer 53 associates the stored gas amounts with the respective container 12 and stores the information in memory. After the container 12 is filled and sealed, the belt conveyor 29 transports the container 12 toward the heating station 31.

Prior to reaching the heating station 31, the temperature of each container 12 is measured by the pyrometer 49. The pyrometer 49 supplies the measured temperature information to the computer 53. The computer 53 associates the temperature information with the respective container 12 and stores the information in memory.

Upon entering the heating station 31, the container 12 moves under the inductive heating element 35. When the container 12 is located under the inductive heating element 35, the inductive heating element 35 and the container 12 become inductively coupled via the magnetic field produced by the inductive heating element. As a result, the container 12 is heated.

Using the stored gas amounts and the temperature, the computer 51 controls the amount and time duration of electrical power applied to the inductive heating element 35. The speed at which the container 12 passes by the energized inductive heating element 35 may also be controlled. The inductive heating element 35 heats the container 12 to raise the pressure within the container to the predetermined elevated pressure, which is generally equal to or greater than 1.5 times the designated fill pressure of the gas within the container 12.

After exiting the heating station 31, the container 12 is allowed to cool. The container 12 then enters a testing station 61 in which the container is tested for actual leaks or one or more other indications of potential inability of the container 12 to maintain the stored gas at a predetermined gas pressure, which may be the designated fill pressure or another pressure.

After one container 12 is moved away from the heating station 31, the belt conveyor 29 transports the next container 12 through the inductive element 35 of the heating station 31. The computer 53 adjusts the amount of heating of the next container 12 based on the stored gas amounts and the temperature of the container 12 as measured by the pyrometer 49.

From the above description of the invention, those skilled in the art will perceive improvements, changes and modifications in the invention. For example, the inductive heating element design, the alternating current frequency, the element to container proximity, and other factors may be altered for controlling the heating of the container for increasing the pressure of the stored gas. Such improvements, changes and modifications within the skill of the art are intended to be covered by the appended claims.

Having described the invention, we claim:

1. A method for assessing whether a container for a stored gas can maintain a predetermined gas pressure, said method comprising the steps of:
producing a magnetic field with an inductive heating element;
placing the container containing a quantity of the stored gas in the magnetic field;
inductively heating the container to elevate the pressure of the stored gas to an elevated pressure greater than the predetermined gas pressure; and thereafter
testing the container for an indication of potential inability of the container to maintain the stored gas at the predetermined gas pressure.

2. The method of claim 1 wherein the container is moved by a conveyor to place the container in the magnetic field.

3. The method of claim 2 further including stopping the conveyor momentarily while the container is in the magnetic field.

4. The method of claim 1 wherein the elevated pressure is at least 1.5 times a designated fill pressure of the stored gas in the container.

5. The method of claim 1 further including the steps of filling the container with gas and sealing the container prior to placing the container in the magnetic field.

6. The method of claim 1 further including the step of providing the container as an inflation fluid source for a vehicle occupant protection system.

7. The method of claim 1 including the step of measuring the temperature of the stored gas in the container before the container is inductively heated.

8. The method of claim 1 wherein the container is a first container and wherein the method includes the steps of measuring the temperature of stored gas in a second container before the second container is inductively heated, placing the second container with stored gas in the magnetic field, inductively heating the second container to elevate the pressure of the stored gas above the predetermined pressure whereby the amount of heating of the second container is adjusted based on the measured temperature of the stored gas in the second container before the second container is inductively heated, and thereafter testing the second container for an indication of potential inability of the second container to maintain the gas at the predetermined gas pressure.

9. The method of claim 1 including providing a computer to adjust the amount of heating of the container.
